(19) United States
(12) Patent Application Publication
(10) Pub. No.: US 2026/0231021 A1
(43) Pub. Date: Aug. 6, 2026

(54) WIRELESS DEVICE AND METHODS PERFORMED THEREBY, FOR PERFORMING IDLE MODE PROCEDURES

(71) Applicant: Telefonaktiebolaget LM Ericsson (publ), Stockholm (SE)

(72) Inventor: Andreas HÖGLUND, Solna (SE)

(21) Appl. No.: 19/151,390

(22) PCT Filed: Feb. 17, 2023
(86) PCT No.: PCT/SE2023/050151

§ 371 Date: Jul. 28, 2025

(51) Int. Cl. H04W 52/02

(52) U.S. Cl. CPC H04W 52/0216; H04W 52/0235

(57) ABSTRACT

Various embodiments provide a method by a wireless device for performing an idle mode procedure in a wireless communications network, a main receiver of the wireless device being in a sleep state. The method includes monitoring, using a low power receiver, while the main receiver is in the sleep state, for a radio signal transmitted periodically at predetermined time occasions, the radio signal being detectable by the low power receiver when the wireless device is in coverage of the wireless communications network, detecting the radio signal using the low power receiver, and performing the idle mode procedure in the wireless communications network in response to detecting the radio signal. Performing the idle mode procedure is conditioned on that the radio signal is detected by the wireless device. A wireless device is also provided for performing an idle mode procedure.

### TECHNICAL FIELD

The present disclosure generally relates to wireless communication networks, and more specifically, to a wireless device, and methods performed therein for performing idle mode procedures.

### BACKGROUND

Nodes within a communications network may be wireless devices such as e.g., User Equipments (UEs), stations (STAs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g., between two wireless devices, between a wireless device and a regular telephone, and/or between a wireless device and a server via a Radio Access Network (RAN), and possibly one or more core networks, comprised within the communications network. Wireless devices may further be referred to as mobile telephones, cellular telephones, laptops, or tablets, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

Nodes may also be network nodes, such as radio network nodes, e.g., Transmission Points (TP). The communications network covers a geographical area which may be divided into cell areas, each cell area being served by a network node such as a Base Station (BS), e.g. a Radio Base Station (RBS), which sometimes may be referred to as e.g., gNB, evolved Node B (“eNB”), “eNodeB”, “NodeB”, “B node”, or Base Transceiver Station (BTS), depending on the technology and terminology used. The base stations may be of different classes such as e.g. Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The communications network may also be a non-cellular system, comprising network nodes which may serve receiving nodes, such as wireless devices, with serving beams. In 3rd Generation Partnership Project (3GPP) Long Term Evolution (LTE), base stations, which may be referred to as eNodeBs or even eNBs, may be directly connected to one or more core networks. The so-called 5G system, from a radio perspective started to be standardized in 3GPP, and the so-called New Radio (NR) is the name for the radio interface. NR architecture is being discussed in 3GPP. In the current concept, gNB denotes an NR BS, where one NR BS may correspond to one or more transmission/reception points.

In the context of this disclosure, the expression Downlink (DL) may be used for the transmission path from the base station to the wireless device. The expression Uplink (UL) may be used for the transmission path in the opposite direction i.e., from the wireless device to the base station.

The Fifth Generation (5G) Packet Core Network may be referred to as Next Generation (NG) Core Network, abbreviated as NG-CN, NGC or 5G CN.

### Internet of Things (IoT)

The Internet of Things (IoT) may be understood as an internetworking of communication devices, e.g., physical devices, vehicles, which may also be referred to as “connected devices” and “smart devices”, buildings and other items—embedded with electronics, software, sensors, actuators, and network connectivity that may enable these objects to collect and exchange data. The IoT may allow objects to be sensed and/or controlled remotely across an existing network infrastructure.

“Things,” in the IoT sense, may refer to a wide variety of devices such as heart monitoring implants, biochip transponders on farm animals, electric clams in coastal waters, automobiles with built-in sensors, DNA analysis devices for environmental/food/pathogen monitoring, or field operation devices that may assist firefighters in search and rescue operations, home automation devices such as the control and automation of lighting, heating, e.g., a “smart” thermostat, ventilation, air conditioning, and appliances such as washer, dryers, ovens, refrigerators or freezers that may use telecommunications for remote monitoring. These devices may collect data with the help of various existing technologies and then autonomously flow the data between other devices.

It is expected that in a near future, the population of IoT devices will be very large. Various predictions exist, among which one assumes that there will be >60000 devices per square kilometer, and another assumes that there will be 1000000 devices per square kilometer. A large fraction of these devices is expected to be stationary, e.g., gas and electricity meters, vending machines, etc.

### Machine Type Communication (MTC)

Machine Type Communication (MTC) has in recent years, especially in the context of the Internet of Things (IoT), shown to be a growing segment for cellular technologies. An MTC device may be a communication device, typically a wireless communication device or simply user equipment, that is a self and/or automatically controlled unattended machine and that is typically not associated with an active human user in order to generate data traffic. An MTC device may typically be simpler, and typically associated with a more specific application or purpose, than, and in contrast to, a conventional mobile phone or smart phone. MTC involves communication in a wireless communication network to and/or from MTC devices, which communication typically may be of quite different nature and with other requirements than communication associated with e.g. conventional mobile phones and smart phones. In the context of and growth of the IoT, it is evident that MTC traffic will be increasing and thus needs to be increasingly supported in wireless communication systems.

Wake-up receiver (WUR), sometimes also referred to as ‘wake-up radio’, may be understood to relate to enabling a low power receiver in UEs, which, in case of the detection of a ‘Wake-up signal’ (WUS), may wake up the main, e.g., baseband/higher power, receiver to detect an incoming message, typically paging, e.g., the Physical Downlink Control Channel (PDCCH) in paging occasions (POs), scheduling the paging message on the Physical Downlink Shared Channel (PDSCH). The main benefit of employing WUR may be understood to be lowering energy consumption and provide for longer device battery life, or at a fixed energy consumption, the downlink latency may be reduced, with shorter Discontinued Reception (DRX)/duty-cycles, and more frequent checks for incoming transmissions.

FIG. 1 is a schematic diagram illustrating location of a WUS and the paging occasion to which it is associated. As an example, three WUS and PO positions are shown in FIG. 1 in white and black blocks.

### WUS for NB-IoT and LTE-M

### Release 15

In Rel-15, WUS was specified for NarrowBand IoT (NB-IoT) and Long Term Evolution for Machines (LTE-M). The main motivation was UE energy consumption reduction since, with the coverage enhancement, PDCCH may be repeated many times and the WUS may be relatively much shorter and hence may require less reception time for the UE. The logic may be understood to be that a UE may check for a WUS a certain time before its PO, and only if a WUS is detected the UE may continue to check for PDCCH in the PO, and if not, which is most of the time, the UE may go back to a sleep state (or a sleep mode) to conserve energy. Due to the coverage enhancements, the WUS may be of variable length depending on the coverage of the UE, see FIG. 2.

FIG. 2 is a schematic diagram illustrating WUS for NB-IoT and LTE-M. The WUS may be configured with a WUS duration equal to or less than a maximum WUS duration. A gap may be between the end of the WUS and the start of the PO.

A WUS may be based on the transmission of a short signal that may indicate to the UE that it may need to continue to decode the Downlink (DL) control channel e.g., the full Narrowband PDCCH (NPDCCH) for NB-IoT. If such signal is absent, e.g., in Discontinuous Transmission (DTX) that is, if the UE does not detect it, then the UE may go back to sleep without decoding the DL control channel. The decoding time for a WUS may be considerably shorter than that of the full NPDCCH since it may only need to contain one bit of information, whereas the NPDCCH may contain up to 35 bits of information. This, in turn, may be understood to reduce UE power consumption and lead to longer UE battery life. The WUS would be transmitted only when there may be a paging for the UE. But if there is no paging for the UE, then the WUS may be understood to not be transmitted, implying a discontinuous transmission (DTX) and the UE may go back to deep sleep e.g., upon detecting DTX instead of WUS. This is illustrated in FIG. 1, where white blocks indicate possible WUS, and PO positions whereas the black boxes indicate actual WUS and PO positions.

The specification of Rel-15 WUS is spread out over several parts of the LTE 36-series standard, e.g., 36.211, 36.213, 36.304 and 36.331.

A UE may report its WUS capability to the network, and its WUS gap capability, see below. Further WUS information was added to the paging message/request from Mobility Management Entity (MME) to an eNB, see UE radio paging capabilities. An eNB may use WUS for paging the UE if and only if (IFF) 1) WUS is enabled in the cell, e.g., WUS-Config may be present in System Information (SI), and 2) the UE supports WUS according to the wakeUpSignal-r15 UE capability, see also the description of WUS gap below.

WUS was introduced for both LTE-M and NB-IoT with support for both DRX and extended DRX (eDRX), the former with a 1-to-1 mapping between the WUS and the PO, and for the latter in an addition with the possible configuration of 1-to-N, i.e. many, POs. An eNB may configure one WUS gap for UEs using DRX, and another one for UEs using eDRX, see e.g., TS 36.331, version 16.6.0, examples are given for NB-IoT, LTE-M is similar:

WUS-Config-NB information element

| | |
|---|---|
| WUS-Config-NB-r15 ::= | SEQUENCE { |
| maxDurationFactor-r15 | WUS-MaxDurationFactor-NB-r15, |
| numPOs-r15 | ENUMERATED {n1, n2, n4} DEFAULT n1, |
| numDRX-CyclesRelaxed-r15 | ENUMERATED {n1, n2, n4, n8}, |
| timeOffsetDRX-r15 | ENUMERATED {ms40, ms80, ms160, ms240}, |
| timeOffset-eDRX-Short-r15 | ENUMERATED {ms40, ms80, ms160, ms240}, |
| timeOffset-eDRX-Long-r15 | ENUMERATED {ms1000, ms2000} OPTIONAL, -- |

Need OP
...
}

| | |
|---|---|
| WUS-ConfigPerCarrier-NB-r15 ::= | SEQUENCE { |
| maxDurationFactor-r15 | WUS-MaxDurationFactor-NB-r15 |

}

| | |
|---|---|
| WUS-MaxDurationFactor-NB-r15 ::= | ENUMERATED {one128th, one64th, |

one32th, one16th,

oneEighth, oneQuarter, oneHalf}

WUS-Config-NB field descriptions

timeOffsetDRX
When DRX is used, non-zero gap from the end of the configured maximum WUS duration to
the associated PO, see TS 36.304 [4], clause 7.4 and TS 36.211 [21]. In milliseconds. Value
ms40 corresponds to 40 ms, value ms80 corresponds to 80 ms and so on.
timeOffset-eDRX-Short
When eDRX is used, the short non-zero gap from the end of the configured maximum WUS
duration to the associated PO, see TS 36.304 [4], clause 7.4 and TS 36.211 [21]. In
milliseconds. Value ms40 corresponds to 40 ms, value ms80 corresponds to 80 ms and so on.
E-UTRAN configures timeOffset-eDRX-Short to a value longer than or equal to
timeOffsetDRX.
timeOffset-eDRX-Long
When eDRX is used, the long non-zero gap from the end of the configured maximum WUS
duration to the associated PO, see TS 36.304 [4], clause 7.4 and TS 36.211 [21]. In
milliseconds. Value ms1000 corresponds to 1000 ms, value ms2000 corresponds to 2000 ms.

The UE capabilities may also indicate the minimum WUS gaps required for the UE to be able to decode POOCH in the associated PO, for DRX and eDRX, respectively, see TS 36.331:

UE-RadioPagingInfo-NB information element

| UE-RadioPagingInfo-NB-r13 ::= | SEQUENCE { | |
|---|---|---|
| ue-Category-NB-r13 | ENUMERATED {nb1} | OPTIONAL, |

...,

| | | |
|---|---|---|
| [[ multiCarrierPaging-r14 | ENUMERATED {true} | OPTIONAL |
| ]], | | |

| | | |
|---|---|---|
| [[ | mixedOperationMode-r15 | ENUMERATED {supported} |

OPTIONAL,

| | |
|---|---|
| wakeUpSignal-r15 | ENUMERATED {true} |

OPTIONAL,

| | wakeUpSignalMinGap-eDRX-r15 | ENUMERATED {ms40, ms240, ms1000, | |
|---|---|---|---|
| ms2000} | OPTIONAL, | | |
| | multiCarrierPagingTDD-r15 | ENUMERATED {true} | OPTIONAL |

]],

| | | |
|---|---|---|
| [[ | ue-Category-NB-r16 | ENUMERATED {nb2} |

OPTIONAL,

| | |
|---|---|
| groupWakeUpSignal-r16 | ENUMERATED {true} |

OPTIONAL,

| | |
|---|---|
| groupWakeUpSignalAlternation-r16 | ENUMERATED {true} |

```
  OPTIONAL
  ]]
}
wakeUpSignalMinGap-eDRX
  wakeUpSignalMinGap-eDRX may be understood to indicate the minimum gap the UE
may support between WUS or Group WUS(GWUS) and associated PO in case of eDRX in
Frequency Division Duplexing (FDD), as specified in TS 36.304, version 16.5.0. Value ms40
corresponds to 40 ms, value ms240 corresponds to 240 ms and so on. If this field is included,
the UE may be required to also indicate support for WUS or GWUS for paging in DRX.
```

At the end of Rel-15, a longer WUS gap of 1 s or 2 s was introduced to enable the use of a Wake-Up receiver (WUR). That is, starting up the main baseband receiver if a WUR is used for the detection of WUS may take longer time. If this is supported in the cell, an eNB may include timeOffset-eDRX-Long in the WUS-Config in SI, see above. In TS 36.304, version 16.5.0, the UE behavior for monitoring paging with WUS is specified, and in Table 7.4-1 it is indicated which WUS time gap the UE and the eNB, may be required to apply depending on the reported UE capability.

| | |
|---|---|
| 7.4 | Paging with Wake Up Signal |

Paging with Wake Up Signal may only be used in the cell in which the UE most recently
entered RRC_IDLE triggered by:

| | |
|---|---|
| - | reception of RRCEarlyDataComplete; or |
| - | reception of RRCConnectionRelease not including noLastCellUpdate; or |
| - | reception of RRCConnectionRelease including noLastCellUpdate and the UE |

was using (G)WUS in this cell prior to this Radio Resource Control (RRC) connection
attempt.
If the UE is in RRC_IDLE, the UE may not be using GWUS according to clause 7.5
and the UE supports WUS, and WUS configuration may be provided in system
information, the UE may be required to monitor WUS using the WUS parameters provided
in System Information. When DRX is used and the UE detects WUS the UE may be
required to monitor the following PO. When extended DRX is used and the UE detects
WUS, the UE may be required to monitor the following numPOs POs or until a paging
message including the UE's Non-Access Stratum (NAS) identity may be received,
whichever may be earlier. If the UE does not detect WUS, the UE may not be required to
monitor the following PO(s). If the UE missed a WUS occasion, e.g., due to cell
reselection, it may monitor every PO until the start of the next WUS or until the paging time
window (PTW) ends, whichever may be earlier.

| | |
|---|---|
| - | numPOs = Number of consecutive Paging Occasions (PO) mapped to one WUS |

provided in system information where (numPOs ≥1).
The WUS configuration, provided in system information, may include a time-offset
between the end of WUS and the start of the first PO of the numPOs POs the UE may be
required to monitor. The timeoffset in subframes, used to calculate the start of a subframe
g0, see TS 36.213, version 16.7.1, may be defined as follows:

| | |
|---|---|
| - | for a UE using DRX, it may be the signalled timeoffsetDRX; |
| - | for a UE using eDRX, it may be the signalled timeoffset-eDRX-Short if timeoffset- |

eDRX-Long is not broadcasted;

| | |
|---|---|
| - | for a UE using eDRX, it may be the value determined according to Table 7.4-1 |

if timeoffset-eDRX-Long is broadcasted.

TABLE 7.4-1
Determination of GAP between end of WUS and associated PO

| | | timeoffset-eDRX-Long | |
|---|---|---|---|
| | | 1000 ms | 2000 ms |
| UE Reported | 40 ms or | timeoffset- | timeoffset- |
| wakeUpSignalMinGap- | not | eDRX-Short | eDRX-Short |
| eDRX | reported | | |
| | 240 ms | timeoffset- | timeoffset- |
| | | eDRX-Short | eDRX-Short |
| | 1000 ms | timeoffset- | timeoffset- |
| | | eDRX-Long | eDRX-Long |
| | 2000 ms | timeoffset- | timeoffset- |
| | | eDRX-Short | eDRX-Long |

The timeoffset may be used to determine the actual subframe g0 as follows, taking into consideration resultant System Frame number (SFN) and/or Hyper Frame SFN (H-SFN) wrap-around of this computation:
g0 = PO − timeoffset, where PO is the Paging Occasion subframe as defined in clause 7.1
For a UE using eDRX, the same timeoffset may apply between the end of WUS and associated first PO of the numPOs POs for all the WUS occurrences for a PTW.
The timeoffset, g0, may be used to calculate the start of the WUS as defined in TS 36.213, version 16.7.1.

In essence, the UE may only use WUR, or timeOffset-eDRX-Long, if it may be capable of starting up the main receiver as quickly as indicated by the value used in SI. If not, it may fall back to using timeOffset-eDRX-Short, without WUR.

FIG. 3 is a schematic diagram illustrating the use of eDRX and DRX WUS gaps for NB-IoT and LTE-M.

Since UEs may share PO, the eNB may, in the worst case, have to transmit up to 3 WUSs for one PO, for example, corresponding to timeoffsetDRX, timeoffset-eDRX-Short, and timeoffset-eDRX-Long.

### WUS UE Grouping Objective in Rel-16

In the Rel-16 WID, it was agreed that WUS should be further developed to also include UE grouping, such that the number of UEs that may be triggered by a WUS may be further narrowed down to a smaller subset of the UEs that may be associated with a specific paging occasion (PO):
The objective is to specify the following set of improvements for machine-type communications for BL/CE UEs.
   Improved DL Transmission Efficiency and/or UE Power Consumption:
. . . .
Specify support for UE-group wake-up signal (WUS) [RAN1, RAN2, RAN4]

The purpose may be understood to be to reduce the false paging rate, that is, to avoid that a given UE may be unnecessarily woken up by a WUS transmission intended for another UE. This features may be referred to as Rel-16 group WUS, or GWUS. However, this is not directly related to WUR and will not further be explained here.

### Rel-17 NR PEI

In Rel-17, discussions started on introducing a WUS for NR, then called ‘Paging Early Indication’ (PEI). However, since at the time no coverage enhancement was specified for NR, the only gain for Rel-17 PEI was for scenarios where a small fraction of UEs may be in bad coverage and with large synchronization error due to the use of longer DRX cycles. The gain for such UEs were that with the use of PEI they would typically only have to acquire one Synchronisation Signal Block (SSB) before decoding PEI, instead of up to 3 SSBs if PEI is not used, value according to UE vendors. Accordingly, for most UEs, Rel-17 PEI may result in gains or increased performance.

Rel-17 PEI may also support UE grouping for false paging reduction, similar to the Rel-16 GWUS above, which may have some gains at higher paging load.

In RAN #93e it was agreed that PEI may be PDCCH-based, as seen from the next subsection, making it much less interesting for WUR, since the main baseband receiver may be understood to be required for decoding PEI.

### ReI-18 NR WUR

In Rel-18, there has been rather large interest to introduce WUR for NR. As explained above, the only specification support needed to be able to use a WUR in the UE, is the specification of a WUS and a long enough time gap between the WUS and the PDCCH in the PO, to allow the UE to start up the main receiver. Therefore, the main difference to Rel-17 PEI may be understood to be that the WUS in Rel-18 should not be PDCCH-based and should allow for a simpler and low power receiver, that is, WUR with simple modulation and detection techniques, e.g., using On-Off Keying (OOK), modulation, and non-coherent detection.

In a Rel-18, a study item on “low-power wake-up signal and receiver for NR” was approved. The relevant justification and objective sections are reproduced below (RP-213645):

• Justification
5G systems are designed and developed targeting for both mobile telephony and vertical
use cases. Besides latency, reliability, and availability, UE energy efficiency may be
understood to be also critical to 5G. Currently, 5G devices may have to be recharged per
week or day, depending on individual's usage time. In general, 5G devices may consume
tens of milliwatts in Radio Resource Control (RRC) idle/inactive state, and hundreds of
milliwatts in RRC connected state. Designs to prolong battery life may be understood to be
a necessity for improving energy efficiency as well as for better user experience.
Energy efficiency may be understood to be even more critical for UEs without a continuous
energy source, e.g., UEs using small rechargeable and single coin cell batteries. Among
vertical use cases, sensors and actuators may be deployed extensively for monitoring,
measuring, charging, etc. Generally, their batteries may not be rechargeable and expected
to last at least few years as described in TR 38.875. Wearables may include smart watches,
rings, eHealth related devices, and medical monitoring devices. With typical battery capacity,
it may be challenging to sustain up to 1-2 weeks as may be required.
The power consumption may depend on the configured length of wake-up periods, e.g.,
paging cycle. To meet the battery life requirements above, an eDRX cycle with large value
may be expected to be used, resulting in high latency, which may be understood to not be
suitable for such services with requirements of both long battery life and low latency. For
example, in a fire detection and extinguishment use case, fire shutters may be understood
to need to be closed and fire sprinklers may need to be turned on by the actuators within 1
to 2 seconds from the time the fire may be detected by sensors, long eDRX cycle may not
meet the delay requirements. eDRX may be understood to not be apparently suitable for
latency-critical use cases. Thus, the intention may be understood to be to study an ultra-low
power mechanism that may support low latency in Rel-18, e.g., lower than eDRX latency.
Currently, UEs may need to periodically wake up once per DRX cycle, which may dominate
the power consumption in periods with no signalling or data traffic. If UEs are able to wake
up only when they may be triggered, e.g., paging, power consumption may be dramatically
reduced. This may be achieved by using a wake-up signal to trigger the main radio and a
separate receiver which may have the ability to monitor wake-up signal with ultra-low power
consumption. Main radio may work for data transmission and reception, which may be
turned off or set to deep sleep unless it may be turned on.
The power consumption for monitoring wake-up signal may depend on the wake-up signal
design and the hardware module of the wake-up receiver used for signal detecting and
processing.
The study may need to primarily target low-power WUS/WUR for power-sensitive, small
form-factor devices including IoT use cases, such as industrial sensors, controllers, and
wearables. Other use cases may be understood to not be precluded, e.g., XR/smart glasses,
smart phones.
• Objective of SI
As opposed to the work on UE power savings in previous releases, this study may not
require existing signals to be used as WUS. All WUS solutions identified may be able to
operate in a cell supporting legacy UEs. Solutions may need to target substantial gains
compared to the existing Rel-15/16/17 UE power saving mechanisms. Other aspects such
as detection performance, coverage, UE complexity, may need to be covered by the
evaluation.
The study item includes the following objectives:

| • | Identify evaluation methodology, including the use cases, and Key Performance | |
|---|---|---|
| | Indicators (KPIs) [RAN1] | |
| | ∘ | Primarily target low-power WUS/WUR for power-sensitive, small form-factor |
| | | devices including IoT use cases, such as industrial sensors, controllers, and |
| | | wearables |
| | | ▪ Other use cases are not precluded |
| • | Study and evaluate low-power wake-up receiver architectures [RAN1, RAN4] | |
| • | Study and evaluate wake-up signal designs to support wake-up receivers [RAN1, | |
| | RAN4] | |
| • | Study and evaluate Layer 1 (L1) procedures and higher layer protocol changes | |
| | needed to support the wake-up signals [RAN2, RAN1] | |
| • | Study potential UE power saving gains compared to the existing Rel-15/16/17 UE | |
| | power saving mechanisms and their coverage availability, as well as latency impact. | |
| | System impact, such as network power consumption, coexistence with non-low- | |
| | power-WUR UEs, network coverage/capacity/resource overhead may need to be | |
| | included in the study [RAN1] | |
| | ∘ | Note: The need for RAN2 evaluation may be triggered by RAN1 when |
| | | necessary. |

For more details on e.g., suggestions on WUR architecture and design, receiver power vs. sensitivity trade-off see e.g., RP-212005, RP-212254, RP-212367, and RP-212427 which were submitted to RAN3 #93-e.

The benefit of WUR is to reduce the energy consumption of the receiver, such that unless there is any paging and data for the UE, it may remain in a power saving state. This may extend the battery life of the device, or alternatively enable shorter downlink latency, e.g., shorter DRX, at a fixed battery life. For short-range communication, the WUR power may be low enough, ~3 uW, that this may even, in combination with energy harvesting, enable that the WUR may be continuously on, that is, DRX or duty-cycling may be not used without the need for a battery. This may be considered as a key enabler of battery-less devices towards 6G.

### IEEE WUR

In IEEE, the support for WUR has been specified to a greater extent than in 3GPP. That is, the focus was on low power WUR from the start, and the design may use WUR not only for receiving the WUS but also other control signals and signaling, such as synchronization and mobility information. This may be understood to allow the stations, corresponding to UEs in 3GPP, to only use the WUR when there may be no user-plane data transmission ongoing.

Similar to the 3GPP solution, the use of WUR may only be enabled in stations and not in access points (APs), that is, for downlink communication only. The AP may advertise that it has WUR operation capability, along with WUR configuration parameters, among other info, in which band/channel WUR may be operational, which may be different from the band/channel used for data transmission using the main receiver, e.g., WUR in 2.4 GHz band but data communication in 5 GHz band. Also, it may be noted that the WUR operating channel may be advertised in the beacon, and that the WUR discovery operating channel may be different from the WUR operating channel. Stations may then request to be configured with WUR mode of operation. This request may have to be granted by the AP, and in case it is granted, the station may be further configured/setup for WUR mode of operation, that is, the configuration may be only valid for the connection to the associated AP, and further, the configuration may have to be torn down/de-configured if WUR is not to be used anymore. Both continuous WUR, that is, the receiver open all the time, and duty-cycled WUR, that is, receiver only open during preconfigured time slots, mode of operations may be supported. For the latter, the length of the duty-cycles and on-time during wake up may be part of the WUR configuration.

Unlike the 3GPP solution, the WUR operation mode may be understood to be a “sub-state” of the regular operation and upon the detection of a WUS transmission from the AP, the station may resume the power saving mechanism it may have been configured with before entering the WUR operation mode. That is, IEEE has specified a number of different power saving mechanisms, and for example if duty-cycled monitoring of the downlink has been configured for the station, it may switch to that upon detection of the WUS, unlike the specified 3GPP mechanism which may only cover paging, and the UE may continue to monitor PDCCH if WUS is detected. In this way, the IEEE WUR functionality is more general, and may still allow for the station to, upon detection of WUS, “monitor paging” by checking in the beacon from the AP for which stations there is data, or for the station to directly respond with an uplink transmission.

A station receiving the IEEE WUS may need to synchronize to the wireless medium prior to performing any transmissions, that is, using sync info in the beacon from the AP, typically transmitted every 100 ms, or from the transmission to another station. Synchronization to the wireless medium may be understood to refer to the following in IEEE 802.11; a station changing from sleep to awake in order to transmit may have to perform channel clear assessment until it may receive one or more frames that may allow it to correctly set the virtual carrier sensing. This is to prevent collisions with transmissions from hidden nodes. Essentially, the virtual carrier sensing may tell a station to defer for a time period even if the wireless medium may appear to be idle, and may be set by receiving frames that may indicate the duration of an ongoing frame exchange. It may be noted that in WiFi typically, one beacon transmission may be enough to sync for the station, that is, no need to acquire several transmission due to poor coverage. Unlike operation in licensed bands, the station may also have to apply carrier sensing, and also possibly re-acquire channel sensing parameters, before uplink transmission.

The physical wake-up signal (WUS) in IEEE may contain complete frames which may have to be processed by the station. The drawback with this design may be understood to be that it may require more processing and handling and processing in the station, that is, compared to a simple WUR design, which may trigger one pre-defined activity in case WUS may be detected. The benefit may be that it may contain more information and the solution may be more general. The IEEE WUS may contain information to indicate if the WUS may be a WUR sync beacon, see below, a WUR discovery beacon, see below, or a regular WUS, intended to wake the station up. The WUS may also contain proprietary frames, which may e.g., be used to directly turn actuators on/off. The transmission may use on/off keying (OOK) modulation, using Manchester coding, but may be using multi-carrier OOK which may be generated by an Orthogonal Frequency Division Multiplexing (OFDM) transmitter, that is, WUR may be enabled as a software upgrade in APs. The WUS may be 4 MHz wide, but a whole 20 MHz channel may be reserved. The WUS may start with a 20 MHz legacy preamble, to allow other stations to perform carrier sense, followed by 4 MHz Manchester coded OOK. Two data rates may be supported: 62.5 kbps and 250 kbps, and link adaptation may be up to the AP, each packet may be self-contained and include the data rate, that is, in the WUR there may be two possible sync words used to signal the data rate.

The WUS may contain the following information:
Station Identifier (ID), or group ID, grouping of stations may be supported
Payload up to 22 bytes.
Short frames may contain only basic info; which WUR frame type+addressing.
Ordinary frames may contain control info, and in addition proprietary info.
WUR beacons may contain Basic Service Set Identifier (BSS-ID), sync information, time counter.
Similar structure for WUS and WUR beacons, sync words may indicate the data rate, the station may then detect the header, from this, the station may tell if it is WUS or beacon, then check body.
WUR discovery frames may contain mobility related information to allow for lower power scan, see below.

Regarding mobility, both WUR sync beacons and WUR discovery beacons have been specified, which may only require the WUR to be used for reception, such that stations may stay in the WUR operation mode unless there is data transmission for the station. That is, stations may only need to switch back to legacy Power Saving Mode (PSM) upon WUS detection, or when moving to a new AP. WUR sync beacons may be used by stations to obtain rough synchronization, for data transmission the legacy beacon may be required to still be acquired, and WUR discovery beacons may be used to carry (legacy) mobility information to enable quick/low energy scanning, allowing stations, only using the WUR, to get information related to local and roaming scans for nearby APs, e.g., Service Set Identity (SSID) and main radio operating channels, if the channel quality should deteriorate.

That is, in the WUR discovery beacon, the AP may indicate one or more Basic Service Set (BSS), and the BSS-ID may have a one-to-one mapping with the assigned SSID name, in which WUR may be supported such that stations may not have to scan all frequencies/channels. The WUR discovery beacon may contain the legacy mobility information, which may mean there may be some duplication/redundancy in the broadcasted information. This may allow for low power scanning, using only the WUR. Note however that mobility in IEEE may be restricted to the same AP, and that hand-over between APs etc. may not be supported in the same way as in 3GPP. If a station in WUR operation mode moves to a new AP, it may have to move out of WUR operation mode and use the main receiver to obtain the beacon, sync, configuration, and associate to the new AP.

### Battery-Less IoT

During the preparation phase of Release 18 in 3GPP, several companies proposed a similar solution for a lower UE segment for IoT. The device complexity may be really low and the form factor very small, and the devices may even be printable electronics. The main use cases may be barcode replacement, item tracking and status for logistics, automatic inventory, industrial application, agriculture, etc. Transmissions from the battery-less IoT devices has been proposed to be based either on backscattering communication or energy harvesting. The drawback with the former is the short range which may be achieved, which has led to a somewhat larger focus on energy harvesting, which may then require an energy storage which may increase the form factor somewhat. With energy harvesting operation, the UE may harvest energy from the environment, e.g., Radio Frequency (RF), vibrational, thermal, etc. until the energy storage, e.g., a super-capacitor, may have a sufficient energy level to perform the intended transmission, e.g., a data report transmission in uplink. During the energy harvesting phase it may be understood to be important to minimize the energy consumption of the device, and therefore the use of a WUR may be understood to be beneficial.

The outcome of the most recent RAN email discussion on battery-less IoT, there referred to as ‘Passive IoT’, may be found in RP-212688. See also relevant RAN contributions on the topic in RP-213368, RP-213369, RP-211990, RP-212135, S2-2107084, S1-214144, S1-214134, S1-214149.

### SUMMARY

Various embodiments of the present disclosure propose a solution for performing an idle mode procedure, which can avoid cell search, cell selection and reselection, and downlink monitoring of the UE's paging occasions, and the associated energy and resource waste, when UEs are out of coverage. The benefit could be to provide longer device battery life and/or reduce energy consumption.

According to a first aspect of the present disclosure, there is provided a method performed by a wireless device for performing an idle mode procedure in a wireless communications network. A main receiver of the wireless device is operable to be put in a sleep state and the method comprises: monitoring, using a low-power receiver, while the main receiver is in the sleep state, for a radio signal transmitted periodically at predetermined time occasions, the radio signal being detectable by the low-power receiver when the wireless device is in coverage of the wireless communications network; detecting the radio signal using the low-power receiver; and performing the idle mode procedure in the wireless communications network in response to detecting the radio signal, wherein performing the idle mode procedure is conditioned on that the radio signal is detected by the wireless device.

According to a second aspect of the present disclosure, there is provided an apparatus which may be implemented as a wireless device. The wireless device is configured for performing an idle mode procedure in a wireless communications network, a main receiver of the wireless device being operable to be put in a sleep state, and the wireless device being configured to: monitor using a low-power receiver, while the main receiver is in the sleep state, for a radio signal transmitted periodically at predetermined time occasions, the radio signal being detectable by the low-power receiver when the wireless device is in coverage of the wireless communications network; detect the radio signal using the low-power receiver; and perform the idle mode procedure in the wireless communications network in response to detecting the radio signal, wherein performing the idle mode procedure is conditioned on that the radio signal is detected by the wireless device.

### BRIEF DESCRIPTION OF THE DRAWINGS

Examples of embodiments herein are described in more detail with reference to the accompanying drawings, according to the following description.

FIG. 1 is a schematic diagram depicting an illustration of a location of a WUS and the paging occasion to which it is associated.

FIG. 2 is a schematic diagram depicting an illustration of WUS for NB-IoT and LTE-M.

FIG. 3 is a schematic diagram illustrating the use of eDRX and DRX WUS gaps for NB-IoT and LTE-M.

FIG. 4 is a schematic diagram depicting an example of a wireless communications network, according to embodiments herein.

FIG. 5 is a flowchart depicting a method performed by a wireless device, according to embodiments herein.

FIG. 6 is a schematic diagram illustrating a non-limiting example of C-WUS coverage.

FIG. 7a is a schematic diagram illustrating a non-limiting example of periodically transmitted C-WUS by the wireless communication network.

FIG. 7b is a schematic diagram illustrating a non-limiting example of monitoring action performed by the wireless device.

FIG. 8 is a schematic block diagram illustrating two embodiments, in panel a) and panel b), of a wireless device, according to embodiments herein.

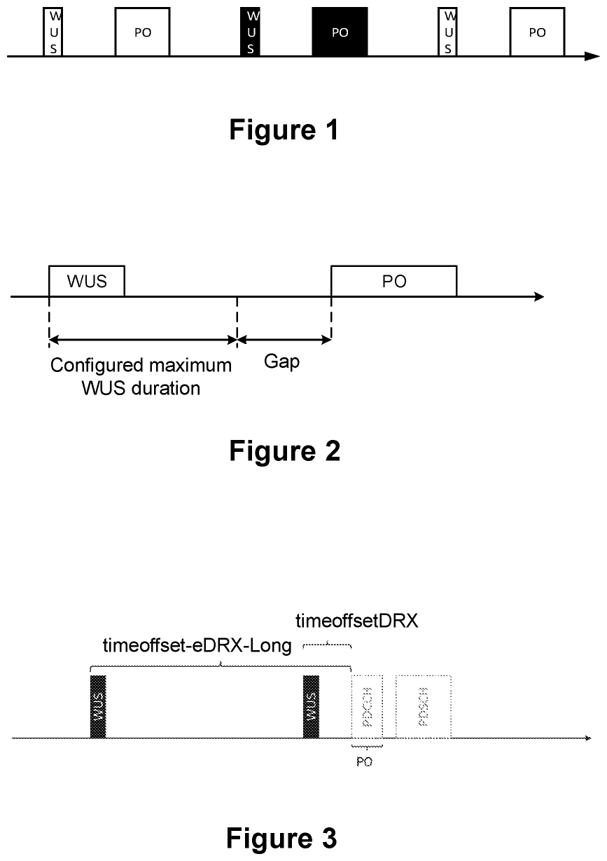

### DETAILED DESCRIPTION

As part of the development of embodiments herein, one or more challenges with the existing technology will first be identified and discussed.

Conventionally, in 3GPP, a UE or wireless device that is in IDLE mode performs idle mode procedures, and initial access, meaning that in legacy procedure, a UE may first perform cell (re-)selection, acquire synchronization and system information, before it may camp on a cell and monitor the downlink in the cell. The Idle mode procedures may at least comprise Public Land Mobile Network (PLMN) selection, localization registration (i.e. informing the core network (CN) of the UE location for paging and downlink reachability), cell selection or re-selection to find a suitable cell to camp on. That is, the UE may perform cell selection or re-selection to find a suitable cell to camp on, which may periodically require the UE to perform Radio Resource Management (RRM) measurements and acquire system information of cells in the vicinity. The UE or wireless device may also monitor the downlink for incoming transmissions, e.g., according to the configured eDRX cycle for the wireless device. This includes monitoring of the UE's paging occasions and cell related information, for example system information update notification, paging short messages, public warnings, e.g. Earth Quake and Tsunami Warning System (ETWS), Commercial Mobile Alert System (CMAS), etc.

For battery-less devices, referred to as Zero-energy IoT (ZE-IoT) and in 3GPP also referred to as ‘Ambient power-enabled IoT’ or ‘X IoT’, both active and passive transmission and reception are considered. Passive transmission refers to backscattering communication. Active transmission can however achieve a considerably longer transmission range, and active battery-less devices rely on energy harvesting in combination with an energy storage (chargeable battery or supercapacitor) or a battery intended to last for the entire device lifetime. For example, “battery-less” refers to that devices do not require battery charging or replacement. In order to achieve a range/coverage longer than for competing solutions, such as Radio-frequency identification (RFID), battery-less devices may be understood to most likely rely on energy harvesting. The better supported coverage/range, the more energy may need to be harvested, which may require several hours.

Even with energy harvesting and active transmissions, the downlink coverage for battery-less IoT may most likely not be as good as regular cellular coverage particularly in macro cells. The coverage may be understood to be more “spotty”, at least in outdoor deployments, and only occasionally the UE/the battery-less device may be in coverage. The inventor has realized that to recurringly try to find a cell to camp on when out of coverage is energy consuming and is not feasible for energy harvesting devices. It is therefore a problem that battery-less energy harvesting devices such as IoT devices may waste energy and resources on unnecessarily triggering and/or performing idle mode procedures when out of coverage. If it may be relatively common that the UE is out coverage, e.g., battery-less IoT devices may in some scenarios be in coverage only rarely, such a procedure is sub-optimal and may cause unnecessary energy consumption. It may therefore be not productive if UEs waste energy on (idle mode) procedures, that is, when the device may be out of coverage. Instead, it may lead to that the UE is energy depleted when later in coverage of the wireless communication network and it needs to transmit or receive within the wireless communication network.

Certain aspects of the present disclosure and their embodiments may provide solutions to these or other challenges. In short, the herein proposed solutions to the above stated problem include that the UE may check whether it is within coverage before performing the (Idle mode) procedures, thus avoiding wasting energy and resources on cell search, cell selection and reselection, and downlink monitoring of the UE's paging occasions.

Embodiments herein may be generally understood to relate to different aspects of wake-up signal (WUS) coverage triggered idle mode procedures, such as monitoring of the downlink at a UE's paging occasions using the coverage wake-up signal. Embodiments herein may be understood to enable avoiding energy waste from the UE attempting idle mode procedures when it may be out-of-coverage. That is, the UE (e.g., main receiver of the UE) may reside in a sleep state and only when the UE enters an area with coverage, idle mode procedures are resumed by the UE, such as monitoring the downlink at the UE's paging occasions (e.g., DRX operation), acquiring system information and updates, and (re-)cell selection. The UE is equipped with a low-power receiver, e.g., a low-power wake-up receiver (WUR), which may operate also when the UE (e.g., main receiver of the UE) is in a sleep state, and a periodically broadcasted WUS (e.g., a coverage-WUS or C-WUS) may inform the UE that it is now in coverage and may trigger an idle mode procedure such as monitoring of the downlink at the UE's paging occasions. In other words, the idle mode procedure is triggered by whether or not the UE in a wireless communications network is in coverage of a radio node operating in the wireless communications network. When the UE determines that it is in coverage of the radio node, it triggers and performs idle mode procedures in the wireless communications network. Otherwise, the UE refrains from performing such idle mode procedures.

Some of the embodiments contemplated will now be described more fully hereinafter with reference to the accompanying drawings, in which examples are shown. In this section, the embodiments herein will be illustrated in more detail by a number of exemplary embodiments. The disclosed subject matter should not be construed as limited to only the embodiments set forth herein; rather, these embodiments are provided by way of example to convey the scope of the subject matter to those skilled in the art. It should be noted that the exemplary embodiments herein are not mutually exclusive. Components from one embodiment may be tacitly assumed to be present in another embodiment and it will be obvious to a person skilled in the art how those components may be used in the other exemplary embodiments.

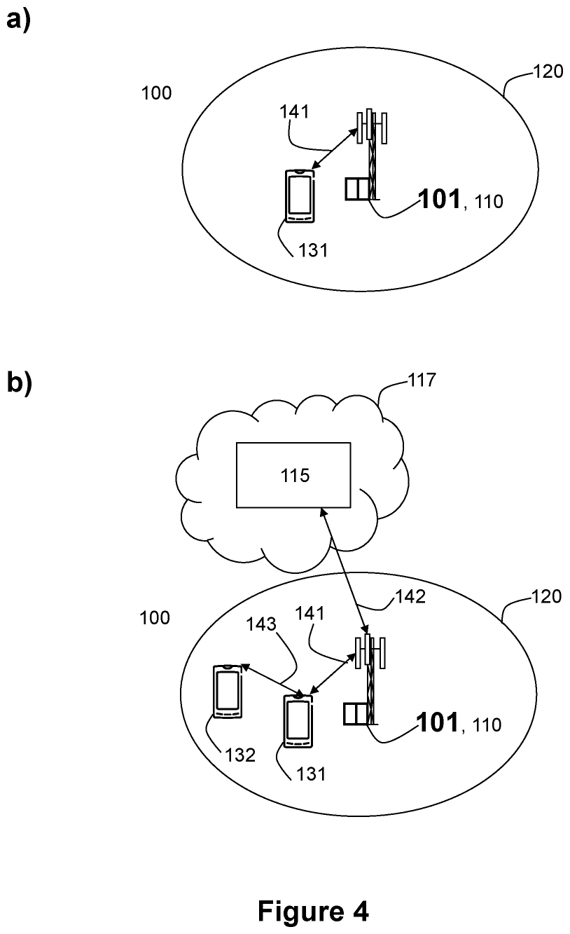

FIG. 4 depicts two non-limiting examples, in panel a) and panel b), respectively, of a wireless network or wireless communications network 100, sometimes also referred to as a wireless communications system, cellular radio system, or cellular network, in which embodiments herein may be implemented. The wireless communications network 100 may be a 5G system, 5G network, or 3GPP Next Generation System or network, or a posterior system with similar functionality. In other examples, the wireless communications network 100 may instead, or in addition, support other technologies such as, for example, Long-Term Evolution (LTE), e.g. LTE-M, LTE Frequency Division Duplex (FDD), LTE Time Division Duplex (TDD), LTE Half-Duplex Frequency Division Duplex (HD-FDD), LTE operating in an unlicensed band, such as LTE LAA, eLAA, feLAA and/or MulteFire. The wireless communications network 100 may typically be support MTC, eMTC, IoT and/or NB-IoT. Yet in other examples, the wireless communications network 100 may support other technologies such as, for example Wideband Code Division Multiple Access (WCDMA), Universal Terrestrial Radio Access (UTRA) TDD, Global System for Mobile communications (GSM) network, GSM/Enhanced Data Rates for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, WiFi networks, Worldwide Interoperability for Microwave Access (WiMax), or any cellular network or system. Thus, although terminology from 5G/NR and LTE may be used in this disclosure to exemplify embodiments herein, this should not be seen as limiting the scope of the embodiments herein to only the aforementioned system.

The wireless communications network 100 may comprise a plurality of nodes, whereof a node 101 is depicted in the non-limiting examples of FIG. 4. The node 101 may be a network node, such as the network node 110 described below. This corresponds to the non-limiting examples depicted in FIG. 4. In some embodiments, the node 101 may be a core network node such as the core network node 115 described below. Yet in other embodiments, the node 101 may be a wireless device, such as the second wireless device 132 described below.

The wireless communications network 100 may comprise a plurality of network nodes, whereof a network node 110 is depicted in the non-limiting example of FIG. 4. The network node 110 may be a radio network node. That is, a transmission point such as a radio base station, for example a gNB, an eNB, an eNodeB, or a Home Node B, a Home eNode B, or any other network node with similar features capable of serving a user equipment, such as a wireless device or a machine type communication device, in the wireless communications network 100. In some examples, such as that depicted in FIG. 4 b), the network node 110 may be a distributed node, and may partially perform its functions in collaboration with a virtual node in a cloud 117.

The wireless communications network 100 may cover a geographical area, which in some embodiments may be divided into cell areas, wherein each cell area may be served by a radio network node, although, one radio network node may serve one or several cells. In the example of FIG. 4, the network node 110 serves a cell 120. The network node 110 may be of different classes, such as, e.g., macro eNodeB, home eNodeB or pico base station, based on transmission power and thereby also cell size. In some examples, the network node 110 may serve receiving nodes with serving beams. The radio network node may support one or several communication technologies, and it may be denoted differently depending on the technology and terminology used. Any of the radio network nodes that may be comprised in the communications network 100 may be directly connected to one or more core networks.

A plurality of wireless devices may be located in the wireless communication network 100, whereof a wireless device 131 is depicted in the non-limiting examples of FIG. 4. In some embodiments, as in the non-limiting example depicted in FIG. 4 b), the wireless communications network 100 may comprise another wireless device 132. Any of the wireless device 131 and the another wireless device 132 comprised in the wireless communications network 100 may be a wireless communication device such as a 5G UE, or a UE, which may also be known as e.g., mobile terminal, wireless terminal and/or mobile station, a mobile telephone, cellular telephone, laptop with wireless capability, a sensor, or an IoT device, just to mention some further examples. Any of the wireless devices comprised in the wireless communications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet, Machine-to-Machine (M2M) device, a sensor, IoT device, NB-IoT device, device equipped with a wireless interface, such as a printer or a file storage device, modem, or any other radio network unit capable of communicating over a radio link in a communications system. The wireless device 131 and the another wireless device 132 comprised in the wireless communications network 100 are enabled to communicate wirelessly in the wireless communications network 100. The communication may be performed e.g., via a RAN, and possibly the one or more core networks, which may be comprised within the wireless communications network 100.

The node 101 may be configured to communicate within the wireless communications network 100 with the wireless device 131 over a first link 141, e.g., a radio link. The network node 110 may be configured to communicate within the wireless communications network 100 with the core network node 115 over a second link 142, e.g., a radio link or a wired link. The wireless device 131 may be configured to communicate within the wireless communications network 100 with the second wireless device 132 over a third link 143, e.g., a radio link or a wired link.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first” and/or “second” herein may be understood to be an arbitrary way to denote different elements or entities, and may be understood to not confer a cumulative or chronological character to the nouns they modify, unless otherwise noted, based on context.

Several embodiments are comprised herein. It should be noted that the examples herein are not mutually exclusive. Components from one embodiment may be tacitly assumed to be present in another embodiment and it will be obvious to a person skilled in the art how those components may be used in the other exemplary embodiments.

More specifically, the following are embodiments related to a wireless device, such as the wireless device 131, e.g., a 5G UE or a UE, and embodiments related to a node, such as the network node 110, e.g., a gNB or an eNB.

A method, performed by a wireless device, such as the wireless device 131 is described herein. The method may be understood to be for performing idle mode procedures. The wireless device 131 may be operating in a wireless communications network, such as the wireless communications network 100.

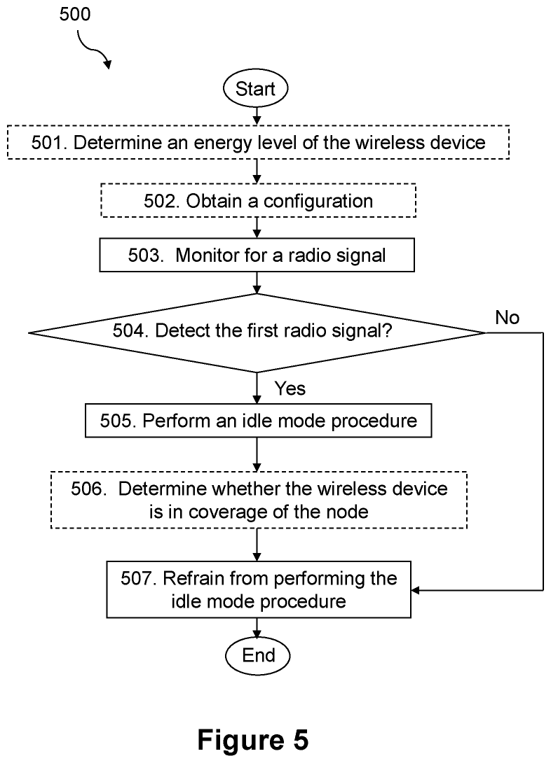

The method may comprise one or more of the following actions. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. In order to simplify the description, it does not include all possible combinations of components. A non-limiting example of the method 500 performed by the wireless device 131 is depicted in FIG. 5. In FIG. 5, optional actions in some embodiments may be represented with dashed lines.
Action 503: Monitoring, using a low power receiver, also called low-power receiver, of the wireless device 131, for a radio signal (e.g., C-WUS) transmitted periodically at predetermined time occasions, while the main receiver of the wireless device 131 is in a sleep state. The sleep state may mean the main receiver is “set to deep sleep” as well as “turned off/switched off”. The radio signal may be detectable by the low power receiver (e.g., low-power wake-up receiver) of the wireless device 131 when the wireless device 131 is in coverage of a wireless communications network 100. The wireless device 131 may be configured to perform the monitoring in this Action 503, e.g. by means of a monitoring unit 901 within the wireless device 131, configured to perform this action.

In this Action 503 a low power receiver may be used, while the main receiver is in the sleep state, to monitor for a radio signal transmitted by the wireless communications network 100 according to a configured periodicity. For example, the radio signal may be detectable by the low power receiver (e.g., low power WUR) of the wireless device 131 when the wireless device 131 is in coverage of the node 101. The node 101 may be operating in a wireless communications network, such as the wireless communications network 100.

In some embodiments, the radio signal may wake up the wireless device 131 from sleep mode. The wireless device 131 may reside in sleep mode until the radio signal wakes up the wireless device 131 from sleep mode. For example, when the wireless device is woken up, the main receiver may be turned on/switched on/leave deep sleep or sleep state in response to the radio signal being detected, and operate accordingly. For example, the main receiver may perform the idle mode procedures accordingly after it is turned on/switched on or leaves the deep sleep or sleep state.

In some embodiments, at least one of the following may apply:
the radio signal may be common to all cells in the wireless communications network.

The radio signal may, in some examples, be referred to herein as a C-WUS,
the radio signal may be periodically transmitted,
the radio signal may be one of: cell specific and network specific,
the radio signal may be any signal detectable by a low power Wake-Up Receiver (WUR),
the radio signal may be a wake-up signal preceding a paging occasion,
the radio signal may be transmitted in addition to a wake-up signal preceding a paging occasion,
the signal or signals to wake-up the wireless device 131 (e.g., wake-up signal(s)) and the radio signal (e.g., C-WUS) may be jointly encoded,
the periodicity of the radio signal may be configured according to an operation mode of the WUR, and
coverage enhancement may be used to monitor the radio signal.

In some examples, the operation mode mentioned above may be an always-on WUR operation, in which case the WUR is continuously receiving. In some examples, the operation mode may be a duty-cycled WUR operation, where the WUR sleeps and receives intermittently.

Both continuous WUR (the receiver open all the time) and duty-cycled WUR (the receiver only open during preconfigured time slots) mode of operations may be supported.
Action 504: Detecting the radio signal using the low power receiver. The wireless device 131 may be configured to perform the detecting in this Action 504, e.g. by means of a detecting unit 902 within the wireless device 131, configured to perform this action.

In other words, the wireless device 131, in Action 503, monitors, using a low power receiver, while the main receiver is in the sleep state, for a radio signal transmitted by the wireless communications network according to a configured periodicity. Performing the idle mode procedure is conditioned on that the radio signal is detected by the wireless device. This means that when the radio signal transmitted at the configured periodicity is detected by the low power receiver in Action 504, the method may further comprise Action 505; otherwise, the method may further comprise Action 507.
Action 505: Performing an idle mode procedure in the wireless communications network 100. The wireless device 131 may be configured to perform the performing in this Action 505, e.g. by means of a Processor 907 within the wireless device 131, configured to perform this action.

In some embodiments, the idle mode procedure is performed by the low power receiver. The main receiver remains in the sleep state to save energy. In some embodiments, the main receiver wakes up i.e., it is turned on/switched on or leaves the deep sleep or sleep state in response to the radio signal being detected by the low-power receiver, e.g. low power WUR, and the idle mode procedure is performed by the main receiver.
Action 507: Refraining from performing the idle mode procedure. This means that when the wireless device is out of coverage, e.g. not in coverage of the wireless communications network, idle mode procedures are not performed. In this way, the wireless device can reduce its power consumption and avoid wasting energy. The wireless device 131 may be configured to perform the performing in this Action 507, e.g. by means of a Processor 907 within the wireless device 131, configured to perform this action.

The idle mode procedure may comprise at least one of: public land mobile network, PLMN, selection, localization registration, monitoring the downlink for paging of the wireless device or monitoring the DL at paging occasions applicable for the wireless device, acquiring system information and updates in a cell in the wireless communications network where the wireless device is located, mobility measurements, cell selection, and cell re-selection.

Whether or not to perform the idle mode procedure may be based on whether or not the wireless device 131 receives or detects the radio signal in Action 504 during the monitoring in Action 503.

When the wireless device 131 receives or detects the radio signal, the wireless device 131 may determine that the wireless device 131 is in coverage in response to detecting the radio signal. In some examples, the radio signal is detectable by the wireless device 131 when the signal has a signal strength above a defined threshold (e.g., a second threshold TH2). The measured signal strength or signal quality (i.e. RSRP or RSRQ) of the radio signal, e.g. C-WUS, would have to be above the defined threshold for the UE to consider itself to be ‘in coverage’. The threshold could either be hard-coded in specification or semi-statically preconfigured, e.g. in system information.

Otherwise, when the wireless device 131 fails to receive or detect the radio signal, that is, during the monitoring 503, the wireless device 131 may refrain from performing the idle mode procedure. If the wireless device 131 is out of coverage of the wireless communications network 100, the radio signal may be too weak to be detected by the wireless device 131. Without such an indication for the wireless device 131 to determine that it is in coverage, it refrains from performing the idle mode procedure so as to avoid wasting energy and resources.

In some embodiments, the method may comprise an action that the wireless device, in response to detecting the radio signal, starts monitoring (by the low-power receiver or by the main power receiver) for PDCCH at its POs and/or monitoring for WUS preceding its POs instead and may stop monitoring for the radio signal. When the PDCCH and/or WUS is not detected as expected, the wireless device may start monitoring for the radio signal again. The main receiver is then put to the sleep state, if it was not woken up.

In FIG. 5, optional steps are indicated with dashed boxes. In some embodiments, the method may further comprise one or more of the following actions:
Action 501: Determining an energy level of the wireless device 131. The method 500 may be performed in response to the determined energy level being below a first threshold TH1, e.g. a defined threshold. For example, this may be when the battery energy of the wireless device 131 is below a certain level. The wireless device 131 may be configured to perform the determining in this Action 501, e.g. by means of the determining unit 904 within the wireless device 131, configured to perform this action.
Action 502: Obtaining a configuration from the node 101. The configuration may indicate how the wireless device 131 is to perform the monitoring in Action 503. The monitoring in Action 503 may be performed based on the configuration. For example, the obtained configuration may comprise a configured periodicity of the radio signal. The periodicity could be configured by the network node 110 to be the same in all cells, i.e. applicable to all cells, in the wireless communications network. Alternatively or additionally, the periodicity could be predetermined or fixed in the specification. The wireless device 131 may be configured to perform the obtaining in this Action 502, e.g. by means of an obtaining unit 905 within the wireless device 131, configured to perform this action.

The configuration may be obtained, e.g., by being received from the network node 110, e.g., from the node 101, e.g., the node 101 being the network node 110 or another node, or by being retrieved from a memory, such as memory 908.

In some examples, the wireless device 131 may perform the monitoring in Action 503 according to a periodicity which is the same as the periodicity of the transmitted radio signal. The wireless device 131 may also perform the monitoring in Action 503 more sparsely to save energy, e.g., by using a periodicity longer than the periodicity of the radio signal. These are non-limiting examples, as the wireless device may perform the monitoring more frequently as well, e.g., with a shorter periodicity than that of the radio signal.

In some embodiments, the method may further comprise one or more of the following actions:
Action 506: Determining whether or not the wireless device 131 is in coverage. The wireless device 131 may be configured to perform the determining in this Action 506, e.g. by means of the determining unit 904 within the wireless device 131, configured to perform this action.

The determining in this Action 506 may be based on whether or not the wireless device 131 may receive or detect the radio signal transmitted e.g. from the node 101, e.g., based on the radio signal having a strength above a second threshold. The wireless device 131 may be configured to receive the radio signal, e.g. by means of the Receiving unit 903 within the wireless device 131, configured to perform this action upon detecting the radio signal.

In some embodiments, the wireless device 131 may use a low power receiver to monitor for the radio signal to save energy and use a main receiver to receive other signals after it is waked up, e.g., is switched on to leave the sleep state. The main receiver may remain in a power saving state (e.g., sleep state) during the period when the wireless device 131 is out of coverage, and only use the low power receiver, which consumes less energy than the main receiver, to monitor for the radio signal.

In some embodiments, the wireless device 131 may be a battery-less IoT device. The node 101 may be one of: the network node 110, the core network node 115, and the another wireless device 132.

Other units 906 may be comprised in the wireless device 131.

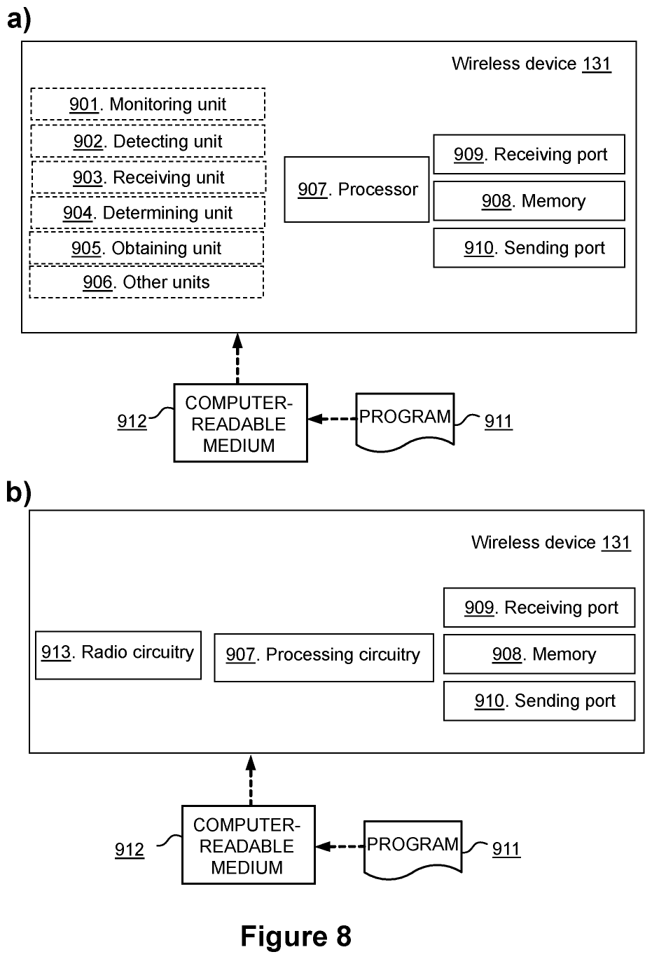

In FIG. 8, optional units are indicated with dashed boxes.

The wireless device 131 may comprise an interface unit to facilitate communications between the wireless device 131 and other nodes or devices, e.g., the node 101, the network node 110, the core network node 115, the another wireless device 132, or any of the other nodes. In some particular examples, the interface may, for example, include a transceiver configured to transmit and receive radio signals over an air interface in accordance with a suitable standard.

The wireless device 131 may comprise an arrangement as shown in FIG. 8.

The method may comprise one or more of the following actions. In some embodiments, all the actions may be performed. In other embodiments, some of the actions may be performed. One or more embodiments may be combined, where applicable. Components from one embodiment may be tacitly assumed to be present in another embodiment and it will be obvious to a person skilled in the art how those components may be used in the other exemplary embodiments. In order to simplify the description, it does not include all possible combinations of components.

Some embodiments herein will now be further described with some non-limiting examples.

In the following description, any reference to a/the UE, or simply “UE” may be understood to equally refer to the wireless device 131; any reference to a/the gNB, a/the “base-station”, or a/the “network” may be understood to equally refer to the node 101; any reference to a/the C-WUS(s) may be understood to equally refer to the radio signal which is detectable by a low power receiver of the wireless device 131 when it is in coverage of the wireless communication network 100.

According to some embodiments of the present invention, if the UE is instead out of coverage, it will not perform the above procedures and stay in a sleep state as much as possible. The UE (Idle mode) procedures and monitoring of the downlink is conditional on that the UE is in coverage. This could be mainly for a UE operating with energy harvesting, which otherwise may have severe performance degradation. The UE may use the low power receiver to monitor, while the main receiver is in the sleep state, for a radio signal transmitted by the wireless communications network 100 according to a configured periodicity or a pre-determined or pre-set periodicity. The radio signal is detectable by the low power receiver when the wireless device is in coverage of the wireless communications network. The low power receiver may detect or receive the radio signal when the UE is in coverage of the node. When the radio signal transmitted at the configured periodicity is detected by the UE, the UE performs the idle mode procedure in the wireless communications network 100 in response to detecting the radio signal, otherwise the UE refrains from performing the idle mode procedure.

According to a first group of examples of embodiments herein, the battery-less IoT device may be using a wake-up receiver (WUR) to determine if it is in coverage or not while the main radio may be in a power saving state (e.g., sleep state) to harvest energy. That is, the UE in the sleep state is using the low power WUR to monitor for a coverage wake up signal (C-WUS) with a certain, e.g. network specific, periodicity and configuration. The C-WUS is a radio signal that is transmitted periodically at predetermined time occasions from the wireless communication network and is detectable by the low power WUR when the UE is in coverage of the wireless communication network. The periodically transmitted radio signal is monitored for and expected (to be detected/received) by the wireless device at predetermined time occasions. In some examples, the C-WUS may be the same in all cells to avoid the need for the UE to acquire system information (SI) before monitoring. The C-WUS and its configurations could be pre-configured or fixed in specification. While the UE harvesting energy in the sleep state the main radio, if used, is turned off.

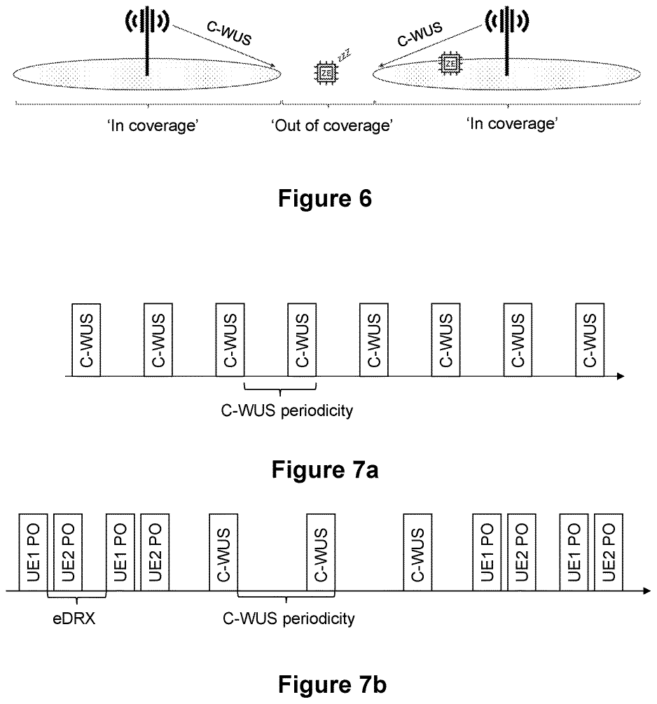

The WUR may enable the base-station to transmit a wake-up signal (WUS) to the UE for downlink reachability and data transmission. According to embodiments herein, base-stations may periodically broadcast a common WUS to UEs to indicate to them that they are in coverage. This common WUS may be here referred to as ‘Coverage WUS’ or C-WUS. Any base-station supporting battery-less IoT devices may there in this case broadcast the C-WUS according to the common network configuration (fixed in specification or configurable). In case the C-WUS does not wake up the UE, i.e., when the UE is out of coverage so the UE does not detect the C-WUS, the UE will remain in a sleep state and pause all Idle mode procedure activities and not monitor the downlink for incoming transmissions. This is schematically illustrated in FIG. 6. FIG. 6 is a schematic diagram illustrating a non-limiting example of C-WUS coverage. When the UE is in coverage, the UE may periodically be woken up by detecting the C-WUS, the main power receiver may be turned on (e.g., leave the sleep state) in response to the C-WUS being detected by the low power WUR and the idle mode procedure is performed by, or using, the main receiver. In other embodiments, when the UE detects the C-WUS using the low power WUR, that is, the UE is in coverage, the main power receiver may still be turned off and the idle mode procedure is performed by, or using, the low power WUR.

One example of an outdoor scenario may be parcel tracking. In this example a wireless device or a tag is put on a parcel to be able to track a delivery. In a warehouse there is full coverage of a network and the wireless device is camped on a cell providing such coverage and monitoring the downlink transmission (e.g. for inventory request etc.). Later when being delivered, there could be in general no coverage of the network for the parcel on roads etc. and the wireless device may remain in a sleep state to preserve energy. However, in the shipping company's intermediate storage and at the customer there may be coverage of new networks again and the broadcasted radio signal, e.g. C-WUS, once being detected by a low power receiver of the wireless device, will trigger the Idle mode procedures and downlink monitoring in the wireless device. Performing the idle mode procedure is conditioned on that the radio signal, e.g. C-WUS, is detected by the wireless device. In this way, it can be ensured that the wireless device is reachable wherever there is coverage, e.g., for status update request or localization request, while at the same time energy is preserved when the wireless device is out of coverage and no radio signal such as C-WUS is detected by the wireless device, meaning that idle mode procedures are not performed by the wireless device.

In some examples of embodiments herein, the radio signal or C-WUS may be a specific signal, e.g., a code sequence, dedicated for the purpose. It may either be cell specific or network specific, e.g., common to or same in the entire network. In other examples of embodiments herein, any other common, e.g., cell specific or network specific, signal which may be detected using a WUR may repurposed to be used as the C-WUS. For example, a WUR sync signal, a WUR-SSB, similar to legacy SSB content and purpose but possible to receive using the WUR, a WUR-System Information (SI) broadcast (system information possible to receive using the WUR), etc. In this way, any radio signal that can be detected by the low power receiver could act as an indication that the UE is in coverage and may start or resume the Idle mode procedures and downlink monitoring.

In some examples of embodiments herein, the broadcast of the C-WUS may be coordinated with paging occasions (POs) used for WUS in the cell, such that no addition wake-up from the sleep state may be required for a given UE. For example, if 4 POs are configured in the cell per System Frame Number (SFN) cycle, C-WUS may be transmitted in or preceding all of them to ensure that any UE in the cell may be reached, e.g., UEs may be distributed over the 4 different POs, and a given UE may only monitor paging and WUS at one of them. See e.g., 3GPP TS 38.304 for details. In an alternative embodiment of the above, the C-WUS occasions may be adjacent to the POs, to minimize the time the UE may have to stay out of the sleep state, but in non-overlapping time- and frequency-resources for the UE to receive both WUS for paging and C-WUS.

In some examples of embodiments herein, the C-WUS and the WUS for paging may be jointly encoded. For example, C-WUS may be a base version of a signal transmitted in every PO, but an alteration of the signal may mean that the UE in this PO in addition may need to wake up to monitor paging, e.g., according to legacy WUS/WUR procedure. The alteration may be a modification of, or a different, code sequence, transmission in a different frequency- or time-resource, or if WUS may carry a payload a bit set separately in the data payload, e.g., a flag. An example of the latter may be the broadcast of a WUR-SSB, e.g., synchronization and system information needed for the WUR operation in a cell. A data field may indicate if UEs may need to, in addition, wake-up or continue to monitor paging. UE multiplexing may be achieved by distributing UEs over several POs, e.g., ‘quasi-random’ based on UE_ID, or the data field may use multiple bits to indicate which paging groups may be being paged, again, possibly distributed “uniformly” based on UE_ID.

The UEs downlink monitoring may therefore depend on whether the UE is in (C-WUS) coverage or not. If it is in coverage, it may monitor paging occasions (POs) and/or WUS according to the UE-specific DRX or eDRX cycle lengths it has been configured with. This means that the UE, i.e. the wireless device, in response to detecting the radio signal, e.g. C-WUS, may instead start monitoring its POs for PDCCH and/or, if configured, start monitoring for WUS preceding its POs. This is illustrated in FIG. 7b. If the UE is out of coverage, e.g. when no longer detecting PDCCH and/or WUS as expected, it may monitor the C-WUS occasions which would typically be sparser in time (to reduce overhead since it is an always-on signal) and which are common to all UEs. This is illustrated in FIG. 7b, which is a schematic diagram illustrating monitoring performed by the UE. FIG. 7a is a schematic diagram illustrating a non-limiting example of periodically transmitted C-WUS by the wireless communications network. In some examples, the wireless device 131 may perform the monitoring in Action 503 according to a periodicity which is the same as the periodicity of the transmitted C-WUS. The wireless device 131 may also perform the monitoring in Action 503 more sparsely to save energy, e.g., by using a periodicity longer than the periodicity of the C-WUS. These are non-limiting examples, as the wireless device may perform the monitoring more frequently as well, e.g., with a shorter periodicity than that of the C-WUS.

The UE procedures conditional on the C-WUS coverage could be summarized as follows:

### Out-of-Coverage:

Monitor C-WUS (with a configured or predetermined periodicity, which could be the same in the entire NW, i.e. fixed).

### In-Coverage:

PLMN selection
Cell selection and re-selection
Location registration
UE monitors DL according to configured power saving mechanism, e.g. eDRX. (Implications for PSM?)
UE acquires Physical Cell ID (PCI), sync, SI and camps on a cell.
UE monitors for SI update
Sidelink discovery

In other examples of embodiments herein, monitoring for C-WUS may be enabled based on the UE battery level and energy harvesting pattern. For example, if for a period of time the UE has sufficient battery and have access to relatively sustainable energy source, e.g., sufficient energy harvesting, then C-WUS may not be necessary. Otherwise, if the battery level is below a certain threshold, C-WUS may be employed for power saving. One example is if solar energy is used for harvesting, in which case the present invention might only be used during night-time.

In other examples of embodiments herein, the C-WUS periodicity/configuration may change overtime depending on various factors such as mobility pattern, coverage condition, and energy availability. For example, C-WUS may need to be used more frequently for moving devices while less frequently for stationary devices.

In yet other examples of embodiments herein, the C-WUS periodicity may be linked to the WUR operation mode. In general, WUR operation may be continuous, that is, always on, or duty-cycled, that is, periodically on and off. In case a duty-cycled WUR is employed to monitor C-WUS, the periodicity of C-WUS may depend on the WUR DRX cycle.

In some examples of embodiments herein, the measured signal strength or signal quality, e.g., Reference Signal Received Power (RSRP) or Reference Signal Received Quality (RSRQ) of the C-WUS may have to be above a defined threshold for the UE to consider itself to be ‘in coverage’. The threshold may either be hard-coded in specification or semi-statically preconfigured, e.g., in system information.

In some examples of embodiments herein, it may be configured by the network in which radio resources and with which periodicity the UE may need to monitor for C-WUS, which may or may not be the same as the monitoring for paging, see above. In another embodiment, this is fixed in specification.

In some examples of embodiments herein, WUS may not be used, but any other, e.g., legacy, downlink signal that would be detectable by the low-power WUR may be used. For example, if the UE may wake up and not measure any SSB to be above a pre-determined threshold, e.g., configured by the network, the UE may consider itself ‘out of coverage’, go back to a sleep state and refrain from performing idle mode procedure until the ‘in coverage’ conditions may be fulfilled.

Since WUR may need to have significantly lower complexity and power consumption than the main receiver, its sensitivity/coverage may be slightly lower than that of the main radio. In such a scenario, even if the UE is in the coverage, the WUR may not detect C-WUS, and thus it may not wake up the main radio and/or the idle mode procedure(s) is/are not performed. One way to alleviate this situation may be to consider coverage enhancements for C-WUS. For instance, C-WUS repetition or power boosting may be applied for coverage enhancement. This may reduce the miss-detection probability for WUR operation.

Certain embodiments disclosed herein may provide one or more of the following technical advantage(s), which may be summarized as follows. Embodiments herein may be understood to enable to avoid performing idle mode procedures, and the associated energy and resource waste, when UEs is or may be out of coverage, mainly for UE's operating with energy harvesting, which may otherwise have severe performance degradation.

FIG. 8 depicts two different examples in panels a) and b), respectively, of the arrangement that the wireless device 131 may comprise to perform the method actions described above in relation to FIG. 5. In some embodiments, the wireless device 131 may comprise the following arrangement depicted in FIG. 8 a).

The wireless device 131 may be implemented through one or more processors, such as a processor 907 in the wireless device 131 depicted in FIG. 8 a), together with computer program code for performing the functions and actions of the embodiments herein. A processor, as used herein, may be understood to be a hardware component. The program code mentioned above may also be provided as a computer program product, for instance in the form of a data carrier carrying computer program code for performing the embodiments herein when being loaded into the wireless device 131. One such carrier may be in the form of a CD ROM disc. It is however feasible with other data carriers such as a memory stick. The computer program code may furthermore be provided as pure program code on a server and downloaded to the wireless device 131.

The wireless device 131 may further comprise a memory 908 comprising one or more memory units. The memory 908 is arranged to be used to store obtained information, store data, configurations, schedulings, and applications etc. to perform the methods herein when being executed in the wireless device 131.

In some embodiments, the wireless device 131 may receive information from, e.g., the node 101, the network node 110, the core network node 115, the another wireless device 132 or another node, through a receiving port 909. In some embodiments, the receiving port 909 may be, for example, connected to one or more antennas in wireless device 131. In other embodiments, the wireless device 131 may receive information from another structure in the wireless communications network 100 through the receiving port 909. Since the receiving port 909 may be in communication with the processor 907, the receiving port 909 may then send the received information to the processor 907. The receiving port 909 may also be configured to receive other information.

The processor 907 in the wireless device 131 may be further configured to transmit or send information to e.g., the node 101, the network node 110, the core network node 115, the another wireless device 132, another node, or another structure in the wireless communications network 100, through a sending port 910, which may be in communication with the processor 907, and the memory 908.

Those skilled in the art will also appreciate that the different units 901-906 described above may refer to a combination of analog and digital modules, and/or one or more processors configured with software and/or firmware, e.g., stored in memory, that, when executed by the one or more processors such as the processor 907, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different units 901-906 described above may be implemented as one or more applications running on one or more processors such as the processor 907.

Thus, the methods according to the embodiments described herein for the wireless device 131 may be respectively implemented by means of a computer program 911 product, comprising instructions, i.e., software code portions, which, when executed on at least one processor 907, cause the at least one processor 907 to carry out the actions described herein, as performed by the wireless device 131. The computer program 911 product may be stored on a computer-readable storage medium 912. The computer-readable storage medium 912, having stored thereon the computer program 911, may comprise instructions which, when executed on at least one processor 907, cause the at least one processor 907 to carry out the actions described herein, as performed by the wireless device 131. In some embodiments, the computer-readable storage medium 912 may be a non-transitory computer-readable storage medium, such as a CD ROM disc, or a memory stick. In other embodiments, the computer program 911 product may be stored on a carrier containing the computer program 911 just described, wherein the carrier is one of an electronic signal, optical signal, radio signal, or the computer-readable storage medium 912, as described above.

The wireless device 131 may comprise a communication interface configured to facilitate communications between the wireless device 131 and other nodes or devices, e.g., the node 101, the network node 110, the core network node 115, the another wireless device 132, another node, or another structure in the wireless communications network 100. The interface may, for example, include a transceiver configured to transmit and receive radio signals over an air interface in accordance with a suitable standard.

In other embodiments, the wireless device 131 may comprise the following arrangement depicted in FIG. 8 b). The wireless device 131 may comprise a processing circuitry 907, e.g., one or more processors such as the processor 907, in the wireless device 131 and the memory 908. The wireless device 131 may also comprise a radio circuitry 913, which may comprise e.g., the receiving port 909 and the sending port 910. The wireless device 131, and/or the radio circuitry 913 and/or the processing circuitry 907 may be configured to, or operable to, perform the method actions according to FIG. 5, in a similar manner as that described in relation to FIG. 8 a). The radio circuitry 913 may be configured to set up and maintain at least a wireless connection with the node 101, the network node 110, the core network node 115, the another wireless device 132, another node, or another structure in the wireless communications network 100. Circuitry may be understood herein as a hardware component.

Hence, embodiments herein also relate to the wireless device 131 comprising the processing circuitry 907 and the memory 908, said memory 908 containing instructions executable by said processing circuitry 907, whereby the wireless device 131 is operative to perform the actions described herein in relation to the wireless device 131, e.g., in FIG. 5.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the expression “at least one of:” followed by a list of alternatives separated by commas, and wherein the last alternative is preceded by the “and” term, may be understood to mean that only one of the list of alternatives may apply, more than one of the list of alternatives may apply or all of the list of alternatives may apply. This expression may be understood to be equivalent to the expression “at least one of:” followed by a list of alternatives separated by commas, and wherein the last alternative is preceded by the “or” term.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method performed by a wireless device for performing an idle mode procedure in a wireless communications network, a main receiver of the wireless device being operable to be put into a sleep state, the method comprising:
monitoring, using a low-power receiver, while the main receiver is in the sleep state, for a radio signal transmitted periodically at predetermined time occasions, the radio signal being detectable by the low-power receiver when the wireless device is in coverage of the wireless communications network;
detecting (504) the radio signal using the low-power receiver; and
performing the idle mode procedure in the wireless communications network in response to detecting the radio signal, performing the idle mode procedure being conditioned on that the radio signal is detected by the wireless device.

2. The method according to claim 1, further comprising:
determining an energy level of the wireless device, and wherein the method is performed in response to the determined energy level being below a first threshold.

3. The method according to claim 1, further comprising:
obtaining a configured periodicity of the radio signal, wherein the configured periodicity is the applicable for all cells in the wireless communications network.

4. The method according to claim 1, wherein the idle mode procedure is performed by the low-power receiver.

5. The method according to claim 1, wherein the main receiver leaves the sleep state in response to the radio signal being detected and wherein the idle mode procedure is performed by the main receiver.

6. The method according to claim 1, wherein at least one of:
the radio signal is common to all cells in the wireless communications network;
the radio signal is one of: cell specific and network specific;
the radio signal is any signal detectable by a low-power Wake-Up Receiver, WUR;
the radio signal is a wake-up signal preceding a paging occasion;
the radio signal is transmitted in addition to a wake-up signal preceding a paging occasion;
the radio signal and the wake-up signal are jointly encoded; and
the periodicity of the radio signal is configured according to an operation mode of the low-power WUR.

7. The method according to claim 1, the method further comprising:
determining that the wireless device is in coverage in response to detecting the radio signal, wherein the radio signal is detectable when having a signal strength above a second threshold.

8. The method according to claim 1, wherein the idle mode procedure comprises at least one of: public land mobile network, PLMN, selection, localization registration, monitoring the downlink for paging of the wireless device, acquiring system information and updates in a cell in the wireless communications network where the wireless device is located, mobility measurements, cell selection, and cell re-selection.

9. The method according to claim 1, wherein the wireless device is a battery-less Internet of things, IoT, device.

10. A wireless device configured for performing an idle mode procedure in a wireless communications network, a main receiver of the wireless device being operable to be put into a sleep state, and the wireless device being configured to:
monitor using a low-power receiver, while the main receiver is in the sleep state, for a radio signal transmitted periodically at predetermined time occasions, the radio signal being detectable by the low-power receiver when the wireless device is in coverage of the wireless communications network;
detect the radio signal using the low-power receiver; and
perform the idle mode procedure in the wireless communications network in response to detecting the radio signal, performing the idle mode procedure being conditioned on that the radio signal is detected by the wireless device.

11. The wireless device according to claim 10, wherein the wireless device is further configured to:
determine an energy level of the wireless device, and wherein one or more of said monitoring, detecting, and performing is performed in response to the determined energy level being below a first threshold.

12. The wireless device according to claim 10, wherein the wireless device is further configured to:
obtain a configured periodicity of the radio signal, wherein the configured periodicity is the applicable for all cells in the wireless communications network.

13. The wireless device according to claim 10, wherein the idle mode procedure is performed by the low-power receiver.

14. The wireless device according to claim 10, wherein the main receiver leaves the sleep state in response to the radio signal being detected and wherein the idle mode procedure is performed by the main receiver.

15. The wireless device according to claim 10, wherein at least one of:
the radio signal is common to all cells in the wireless communications network;
the radio signal is one of: cell specific and network specific;
the radio signal is any signal detectable by a low-power Wake-Up Receiver, WUR;
the radio signal is a wake-up signal preceding a paging occasion;
the radio signal is transmitted in addition to a wake-up signal preceding a paging occasion;
the wake-up signal and the radio signal are jointly encoded; and
the periodicity of the radio signal is configured according to an operation mode of the low-power WUR.

16. The wireless device according to claim 10, wherein the wireless device is further configured to:
determine that the wireless device is in coverage in response to detecting the radio signal, wherein the radio signal is detectable when having a signal strength above a second threshold.

17. The wireless device according to claim 10, wherein the idle mode procedure comprises at least one of: public land mobile network, PLMN, selection, localization registration, monitoring the downlink for paging of the wireless device, acquiring system information and updates in a cell in the wireless communications network where the wireless device is located, mobility measurements, cell selection, and cell re-selection.

18. The wireless device according to claim 10, wherein the wireless device is a battery-less Internet of things, IoT, device.

19. The method according to claim 2, further comprising:
obtaining a configured periodicity of the radio signal, wherein the configured periodicity is the applicable for all cells in the wireless communications network.

20. The method according to claim 2, wherein the main receiver leaves the sleep state in response to the radio signal being detected and wherein the idle mode procedure is performed by the main receiver.
